(19) United States
(12) Patent Application Publication
(10) Pub. No.: US 2025/0244199 A1
(43) Pub. Date: Jul. 31, 2025

(54) CALIBRATION METHOD FOR A LENS TESTING STATION

(71) Applicant: Cheng Uei Precision Industry Co., Ltd., New Taipei City (TW)

(72) Inventors: Ti Wu, New Taipei City (TW); Chia Hsun Lin, New Taipei City (TW)

(21) Appl. No.: 18/892,541

(22) Filed: Sep. 23, 2024

(30) Foreign Application Priority Data
Jan. 30, 2024 (CN) 202410133268.6

(51) Int. Cl. G01M 11/02; G06T 7/00; G06T 7/80

(52) U.S. Cl. CPC G01M 11/0264; G06T 7/0006; G06T 7/80; G06T 2200/24; G06T 2207/20101; G06T 2207/30164; G06T 2207/30168

(57) ABSTRACT

A calibration method for a lens testing station is described. Install a calibrating lens on a lens holder. The calibrating lens is aligned with a testing pattern. Capture the testing pattern. An image capture unit captures a calibration image. Calculate a central coordinate of the calibration image, and calculate an offset of the central coordinate relative to an original center coordinate. Check whether shot times of the calibration image are less than preset capturing times. Execute the third step when the shot times of the calibration image are less than the preset capturing times, execute the next step when the shot times of the calibration image are equal to the preset capturing times. Calculate an average offset of all stored offsets by a control unit. Add the average offset to the original center coordinate to obtain a corrected original center coordinate.

### CROSS REFERENCE TO RELATED APPLICATIONS

The present application is based on, and claims priority from, China Patent Application No. 202410133268.6, filed Jan. 30, 2024, the disclosure of which is hereby incorporated by reference herein in its entirety.

### BACKGROUND OF THE INVENTION

### Field of the Invention

The present invention generally relates to a calibration method for a lens testing station, and more particularly to a calibration method for a lens testing station which is capable of correcting an own setup variation of the lens testing station quickly and automatically.

### Description of Related Art

Quality requirements for lens products in production lines of factories are stringent. Each lens product which is intended for leaving the factory need achieve conditions of a high precision degree and a low error tolerance degree, so that a lens testing station for testing the lens product must be a platform with a stable environment and a high testing reliability.

Referring to FIG. 8, a conventional lens testing station 100′ includes a base 10′, a lens actuator assembly 20′, a lens holder 30′, an image capture unit 40′, a target actuator assembly 50′ and a control unit (not shown). The conventional lens testing station 100′ tests lenses 70′ which have different specifications through the controllable lens actuator assembly 20′ and the target actuator assembly 50′, and a structure of the conventional lens testing station 100′ has no need of being repeatedly modified.

However, after the conventional lens testing station 100′ proceeds with a prolonged operation, a component of the conventional lens testing station 100′ produces an error due to a servo motor operation deviation or an own loss of a mechanism. The component of the conventional lens testing station 100′ is the lens actuator assembly 20′, the target actuator assembly 50′ or the lens holder 30′, etc. In a current practice, a rotation error of each servo motor must be measured, and driving parameters of all servo motors are modified one by one to ensure that a testing result of a testing pattern 60′ obtained by the conventional lens testing station 100′ is correct. Furthermore, the conventional lens testing station 100′ in the production line is usually calibrated once a week, and each manual calibration of the conventional lens testing station 100′ takes a significant amount of time, so a poor operation efficiency in the factory is caused.

Therefore, it is necessary to provide a calibration method for a lens testing station which is capable of correcting an own setup variation of the lens testing station quickly and automatically, so that proceeding time of calibration operations is reduced, and an efficiency of a factory operation process is improved.

### BRIEF SUMMARY OF THE INVENTION

An object of the present invention is to provide a calibration method for a lens testing station, the lens testing station including a base, a lens actuator assembly fixed on the base, a lens holder mounted on the lens actuator assembly, an image capture unit mounted on the lens holder, a target actuator assembly disposed to one side of the base, a testing pattern arranged at the target actuator assembly, and a control unit electrically connected to the lens actuator assembly, the image capture unit and the target actuator assembly, the image capture unit being positioned at an optical axis of a calibrating lens, the calibration method for the lens testing station comprising steps of: installing the calibrating lens on the lens holder; controlling the lens actuator assembly and the target actuator assembly by the control unit, and the lens actuator assembly and the target actuator assembly being controlled according to preset data, the calibrating lens being aligned with the testing pattern, shot times of a calibration image being returned to zero; capturing the testing pattern by the calibrating lens and the image capture unit, the image capture unit capturing the calibration image and transmitting the calibration image to the control unit; calculating a central coordinate of the calibration image by the control unit, and calculating an offset of the central coordinate relative to an original center coordinate storing in a storage medium of the control unit, the control unit storing the offset in the storage medium of the control unit to make the offset accessible by the control unit, the control unit adding one to the shot times of the calibration image; checking whether the shot times of the calibration image are less than preset capturing times storing in the storage medium by the control unit, repeating the steps of capturing the testing pattern and calculating the central coordinate of the calibration image when the shot times of the calibration image are less than the preset capturing times, executing the next step when the shot times of the calibration image are equal to the preset capturing times; and calculating an average offset of all stored offsets by the control unit, adding the average offset to the original center coordinate to obtain a corrected original center coordinate, and storing the corrected original center coordinate in the storage medium of the control unit, then, when the lens testing station tests an inspecting lens, the control unit using the corrected original center coordinate to replace the original center coordinate to proceed with a test of the lens testing station.

Another object of the present invention is to provide a calibration method for a lens testing station, the lens testing station including a base, a lens actuator assembly fixed on the base, a lens holder mounted on the lens actuator assembly, an image capture unit mounted on the lens holder, a target actuator assembly disposed to one side of the base, a testing pattern arranged at the target actuator assembly, and a control unit electrically connected to the lens actuator assembly, the image capture unit and the target actuator assembly, the image capture unit being positioned at an optical axis of a calibrating lens, the image capture unit capturing a standard image through the calibrating lens, when the lens testing station is initially established, the control unit calculating a center point of the standard image to obtain an original center coordinate, the calibration method for the lens testing station comprising steps of: installing the calibrating lens on the lens holder; controlling the lens actuator assembly and the target actuator assembly by the control unit, the calibrating lens being aligned with the testing pattern, shot times of a calibration image being returned to zero; capturing the testing pattern by the calibrating lens and the image capture unit, the image capture unit capturing the calibration image and transmitting the calibration image to the control unit; calculating a central coordinate of the calibration image by the control unit, and calculating an offset of the central coordinate relative to the original center coordinate storing in the control unit, the control unit storing the offset in the control unit to make the offset accessible by the control unit, the control unit adding one to the shot times of the calibration image; checking whether the shot times of the calibration image are less than preset capturing times storing in the control unit by the control unit, repeating the steps of capturing the testing pattern and calculating the central coordinate of the calibration image when the shot times of the calibration image are less than the preset capturing times, executing the next step when the shot times of the calibration image are equal to the preset capturing times; and calculating an average offset of all stored offsets by the control unit, adding the average offset to the original center coordinate to obtain a corrected original center coordinate, and storing the corrected original center coordinate in the control unit, then, when the lens testing station tests an inspecting lens, the control unit using the corrected original center coordinate to replace the original center coordinate to proceed with a test of the lens testing station.

Another object of the present invention is to provide a calibration method for a lens testing station, comprising: capturing a standard image through a calibrating lens when the lens testing station is initially established, the standard image being arranged at a target actuator assembly, the calibrating lens being mounted to an image capture unit of a lens holder of a lens actuator assembly; calculating a center point of the standard image by a control unit to obtain an original center coordinate; installing a calibrating lens on the lens holder; moving the lens actuator assembly and the target actuator assembly according to an instruction of the control unit, the calibrating lens being aligned with a testing pattern arranged at the target actuator assembly, shot times of a calibration image being returned to zero; capturing the testing pattern by the calibrating lens and the image capture unit, the image capture unit capturing the calibration image and transmitting the calibration image to the control unit; calculating a central coordinate of the calibration image by the control unit, and calculating an offset of the central coordinate relative to the original center coordinate, the control unit storing the offset in the control unit to make the offset accessible by the control unit, the control unit adding one to the shot times of the calibration image; checking whether the shot times of the calibration image are less than preset capturing times storing in the control unit by the control unit, repeating the steps of capturing the testing pattern and calculating the central coordinate of the calibration image when the shot times of the calibration image are less than the preset capturing times; and calculating an average offset of all stored offsets by the control unit when the shot times of the calibration image are equal to the preset capturing times, adding the average offset to the original center coordinate to obtain a corrected original center coordinate, and storing the corrected original center coordinate in the control unit, then, when the lens testing station tests an inspecting lens, the control unit using the corrected original center coordinate as a criterion to determine whether the inspecting lens passes the test.

As described above, the calibration method for the lens testing station uses the corrected original center coordinate as the criterion to determine whether the inspecting lens passes the test, and the calibration method for the lens testing station is capable of correcting an own setup variation of the lens testing station quickly and automatically, so proceeding time of calibration operations is reduced, an accuracy and a reliability of the calibrated lens testing station are simultaneously improved, and an efficiency of a factory operation process is improved.

### BRIEF DESCRIPTION OF THE DRAWINGS

The present invention will be apparent to those skilled in the art by reading the following description, with reference to the attached drawings, in which:

FIG. 1 is a structural diagram of a lens testing station in accordance with the present invention;

FIG. 2 is an inspecting image captured by an inspecting lens at the lens testing station according to the present invention;

FIG. 3 is a flow chart of a testing method of the lens testing station in accordance with the present invention;

FIG. 4 is a flow chart of a calibration method for the lens testing station in accordance with the present invention;

FIG. 5 is a schematic diagram of a standard image captured by a calibrating lens at the lens testing station;

FIG. 6 is a schematic diagram of a calibration image captured by the lens testing station, wherein the lens testing station has been used for a long time;

FIG. 7 is a flow chart of a periodic calibration process of the lens testing station in accordance with the present invention; and

FIG. 8 is a structural diagram of a conventional lens testing station.

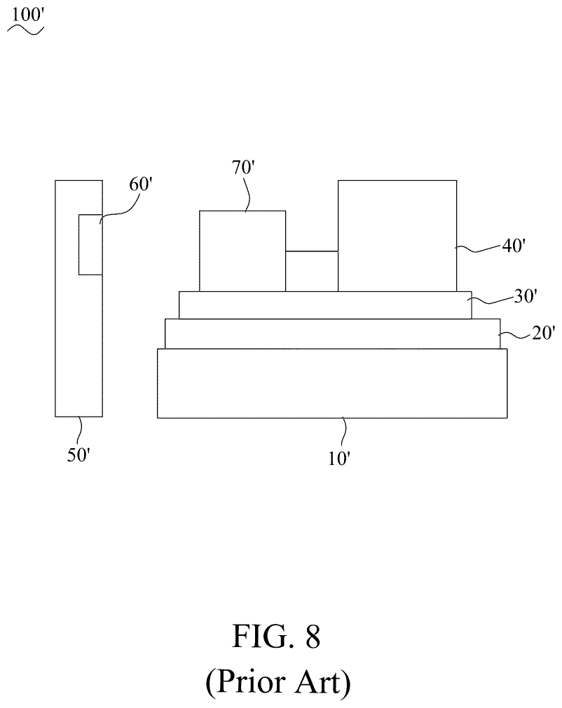

### DETAILED DESCRIPTION OF THE INVENTION

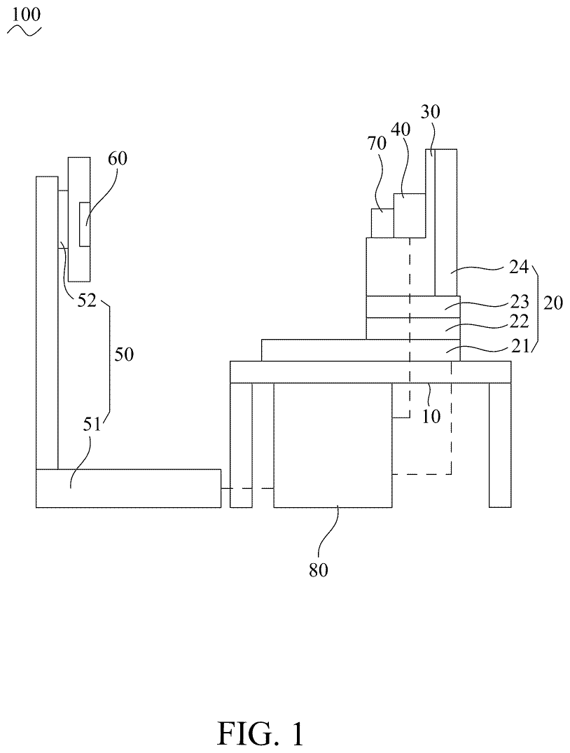

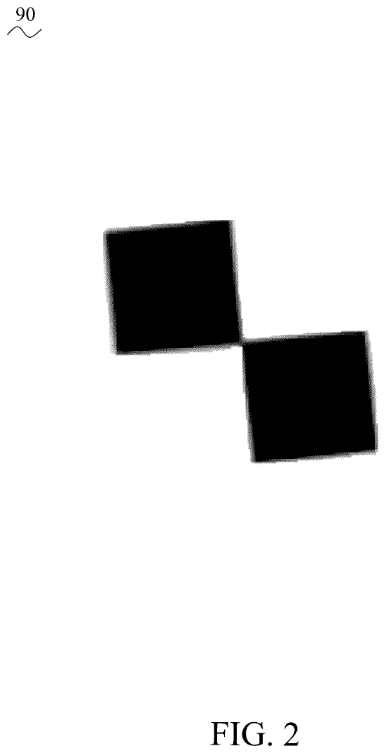

Referring to FIG. 1 and FIG. 2, a calibration method for a lens testing station 100 according to the present invention is shown. The lens testing station 100 includes a base 10, a lens actuator assembly 20 fixed on the base 10, a lens holder 30 mounted on the lens actuator assembly 20, an image capture unit 40 mounted on the lens holder 30, a target actuator assembly 50 disposed to one side of the base 10, a testing pattern 60 arranged at the target actuator assembly 50, and a control unit 80 electrically connected to the lens actuator assembly 20, the image capture unit 40 and the target actuator assembly 50. The lens holder 30 is used for supporting a lens 70. The lens 70 is mounted on the lens holder 30. When the lens testing station 100 proceeds with a testing operation, the lens 70 is an inspecting lens, the inspecting lens is mounted on the lens holder 30, and the lens testing station 100 is set up to test the inspecting lens. When the lens testing station 100 proceeds with a calibrating operation, the lens 70 is a calibrating lens, and the calibrating lens is mounted on the lens holder 30.

A position of the control unit 80 is defined as a lower position of the lens testing station 100. A position of the lens holder 30 is defined as an upper position of the lens testing station 100. A position of the target actuator assembly 50 is defined as a left side of the lens testing station 100. A position of the base 10 is defined as a right side of the lens testing station 100.

The lens actuator assembly 20 includes a first linear sliding rail 21, a second linear sliding rail 22, a first rotating platform 23 and a second rotating platform 24. A track of the first linear sliding rail 21 is parallel to a top surface of the base 10. The second linear sliding rail 22 is connected to a slider of the first linear sliding rail 21. The track of the first linear sliding rail 21 is perpendicular to a track of the second linear sliding rail 22. The first rotating platform 23 is connected to a slider of the second linear sliding rail 22. The second rotating platform 24 is connected to a surface of the first rotating platform 23. The track of the first linear sliding rail 21 is disposed in a left-right direction, and the track of the second linear sliding rail 22 is disposed in a front-rear direction. A rotation axis of the first rotating platform 23 is perpendicular to the top surface of the base 10. A rotation axis of the second rotating platform 24 is perpendicular to the rotation axis of the first rotating platform 23. The rotation axis of the second rotating platform 24 is parallel to the track of the first linear sliding rail 21. The first linear sliding rail 21, the second linear sliding rail 22, the first rotating platform 23 and the second rotating platform 24 are all driven by servo motors, so that the lens holder 30 is in alignment with a specified direction according to an instruction.

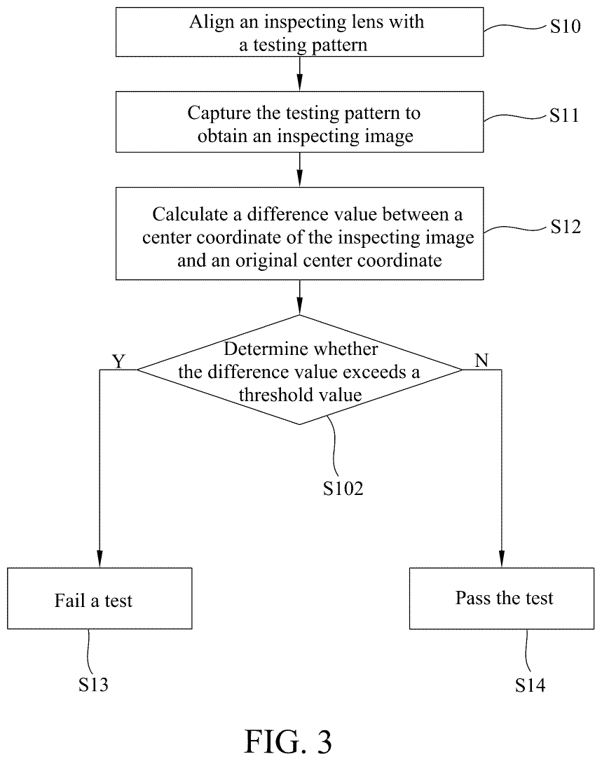

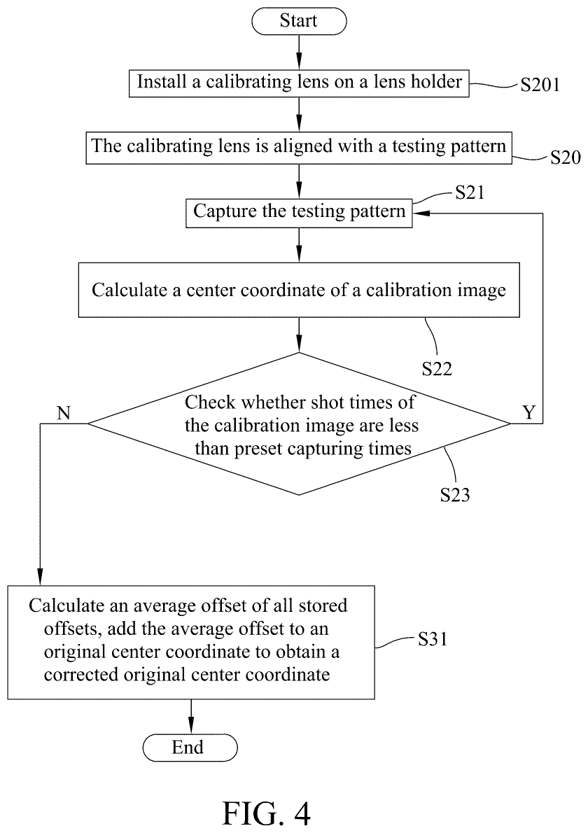

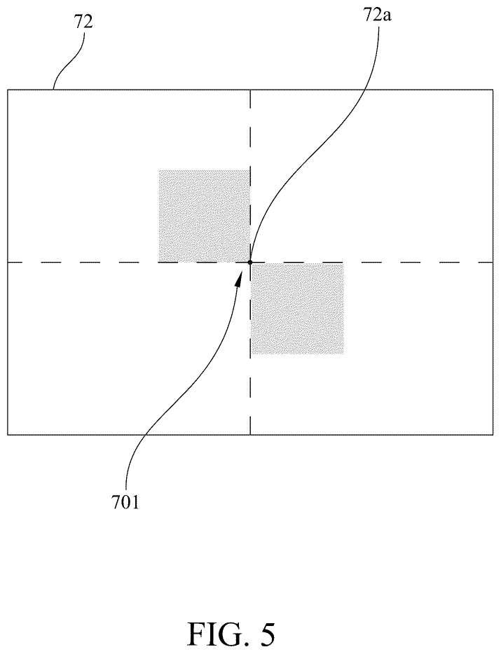

Referring to FIG. 1 to FIG. 5, the lens holder 30 is disposed on the lens actuator assembly 20 to make the lens holder 30 driven by the lens actuator assembly 20, so that the lens holder 30 is in alignment with the specified direction according to the instruction for fixing the inspecting lens. When the slider of the first linear sliding rail 21 slides, the first linear sliding rail 21 brings along the lens holder 30 to move leftward or rightward. When the slider of the second linear sliding rail 22 moves, the second linear sliding rail 22 brings along the lens holder 30 to move frontward or rearward. When the surface of the first rotating platform 23 rotates, the first rotating platform 23 brings along the lens holder 30 to move upward or downward. When a surface of the second rotating platform 24 rotates, the second rotating platform 24 brings along the lens holder 30 to slightly move leftward or rightward. The image capture unit 40 is disposed on the lens holder 30. The image capture unit 40 is positioned at an optical axis of the inspecting lens to capture an inspecting image 90 through the inspecting lens. The inspecting image 90 is captured by the inspecting lens at the lens testing station 100. The image capture unit 40 is positioned at an optical axis of the calibrating lens, and the image capture unit 40 captures a standard image 72 through the calibrating lens. The standard image 72 is captured by the calibrating lens at the lens testing station 100.

The target actuator assembly 50 includes a third linear sliding rail 51, and a third rotating platform 52 disposed to a slider of the third linear sliding rail 51. The track of the third linear sliding rail 51 is disposed in the left-right direction. The track of the third linear sliding rail 51, a rotation axis of the third rotating platform 52 and the track of the first linear sliding rail 21 are parallel. The third linear sliding rail 51 and the third rotating platform 52 are driven by the servo motors. A movement of the slider of the third linear sliding rail 51 drives the testing pattern 60 to move away from or move close to the lens holder 30. A rotation of a surface of the third rotating platform 52 drives the testing pattern 60 to slightly move away from or move close to the lens holder 30, so a relative distance between the testing pattern 60 and the lens holder 30 is adjusted, and a relative angle between the testing pattern 60 and the lens holder 30 is adjusted.

Referring to FIG. 1 and FIG. 2 again, the control unit 80 is electrically connected to the lens actuator assembly 20 and the target actuator assembly 50 to control an operation of cach servo motor in the lens actuator assembly 20 and the target actuator assembly 50. The control unit 80 includes a storage medium. Additionally, the control unit 80 is electrically connected to the image capture unit 40 to receive the inspecting image 90 captured by the image capture unit 40 and calculate assembling errors of the inspecting lens.

Referring to FIG. 1 to FIG. 5, a testing method of the lens testing station 100 includes following steps.

Step S10: control and drive the lens actuator assembly 20 and the target actuator assembly 50 via the control unit 80 to align the inspecting lens with the testing pattern 60.

Step S11: capture the testing pattern 60 by the image capture unit 40 and the inspecting lens to obtain the inspecting image 90, and then transmit the inspecting image 90 to the control unit 80. The inspecting image 90 is generated by the inspecting lens. The inspecting image 90 is an imaging of a visual range of the inspecting lens.

Step S12: calculate a difference value between a center coordinate of the inspecting image 90 and an original center coordinate 72a after the control unit 80 receives the inspecting image 90. The center coordinate of the inspecting image 90 is a coordinate of an intersection point of two black squares in the inspecting image 90. When the lens testing station 100 is initially established, the control unit 80 calculates a center point 701 of the standard images 72 which is generated from the calibrating lens fixed on the lens holder 30 to obtain the original center coordinate 72a. When the lens testing station 100 is initially established, the control unit 80 calculates the center points 701 of the standard images 72 which are generated from multiple calibrating lenses fixed on the lens holder 30 to obtain the original center coordinate 72a. The calibrating lens is inspected and is correctly assembled. The calibrating lens is nearly error-free. A quantity of the multiple calibrating lenses is able to be three.

Step S102: determine whether the difference value exceeds a threshold value via the control unit 80. In practice, the threshold value is 22.6 pixels.

Step S13: if the difference value exceeds the threshold value which is 22.6 pixels, the inspecting lens is determined by the control unit 80 to fail a test.

Step S14: if the difference value is without exceeding the threshold value which is 22.6 pixels, the inspecting lens is determined to pass the test.

The calibrating lenses are inspected and correctly assembled, and the calibrating lens is almost error-free lens, so when the lens testing station 100 is disposed under a correct and error-free status, the standard image 72 captured by the calibrating lenses is without any errors, namely, a center coordinate of the standard image 72 is completely overlapped with a center coordinate of the testing pattern 60. Therefore, the center coordinate of the standard image 72 is defined as the original center coordinate 72a.

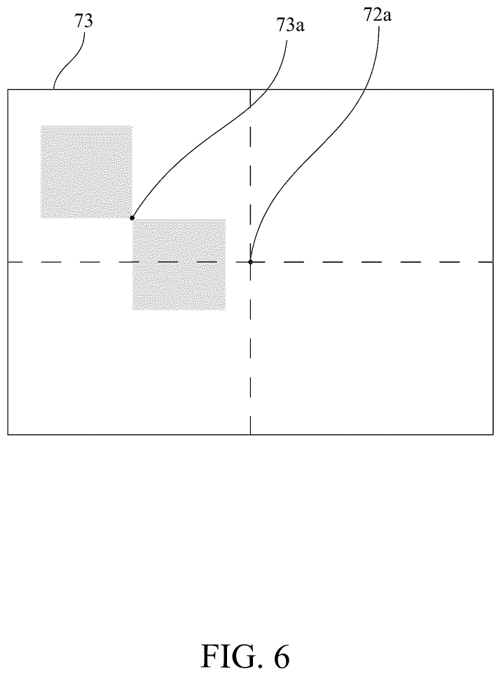

Referring to FIG. 1 to FIG. 6, the calibration method for the lens testing station 100 in accordance with the present invention includes following steps.

Step S201: install the calibrating lens on the lens holder 30 by a user.

Step S20: control the lens actuator assembly 20 and the target actuator assembly 50 by the control unit 80, and the lens actuator assembly 20 and the target actuator assembly 50 are controlled according to preset data, the calibrating lens is aligned with the testing pattern 60, shot times of a calibration image 73 are returned to zero, and then execute step S21.

Step S21: capture the testing pattern 60 by the calibrating lens and the image capture unit 40, the image capture unit 40 captures the calibration image 73 and transmits the calibration image 73 to the control unit 80, and then execute step S22.

Step S22: calculate a central coordinate 73a of the calibration image 73 by the control unit 80, and calculate an offset of the central coordinate 73a relative to the original center coordinate 72a storing in the storage medium of the control unit 80. The control unit 80 stores the offset in the storage medium of the control unit 80 to make the offset accessible by the control unit 80, the control unit 80 counts up the shot times of the calibration image 73, and then execute step S23.

Step S23: check whether the shot times of the calibration image 73 are less than preset capturing times storing in the storage medium of the control unit 80 by the control unit 80. Execute the third step S21 when the shot times of the calibration image 73 are less than the preset capturing times. Execute the next step S31 when the shot times of the calibration image 73 are equal to the preset capturing times. The shot times of the calibration image 73 are the number of times that the image capture unit 40 captures the testing pattern 60 through the calibrating lens. In the practice, a value of the preset capturing times is set to 15.

With reference to FIG. 1 to FIG. 6, when the lens testing station 100 is under the correct and error-free status, the standard image 72 is obtained, the original center coordinate 72a of the standard image 72 is nearly completely overlapped with the center coordinate of the inspecting image 90. The original center coordinate 72a and the center coordinate of the inspecting image 90 are nearly without the offset. When the lens testing station 100 is tested for a long time, the lens actuator assembly 20 has an operation error, the lens holder 30 is worn, namely, the lens testing station 100 is set in error, so that the central coordinate 73a of the calibration image 73 is deviated from the original center coordinate 72a of the standard image 72, the original center coordinate 72a and the central coordinate 73a of the calibration image 73 have the offset.

Step S31: calculate an average offset of all stored offsets by the control unit 80, add the average offset to the original center coordinate 72a to obtain a corrected original center coordinate, and store the corrected original center coordinate in the storage medium of the control unit 80. Then, when the lens testing station 100 tests the inspecting lens, the control unit 80 uses the corrected original center coordinate to replace the original center coordinate to proceed with the test of the lens testing station 100, the control unit 80 uses the corrected original center coordinate as a criterion to determine whether the inspecting lens passes the test.

The calibration method for the lens testing station 100 has no need of calculating error of the servo motors one by one and adjusting driving parameters of the servo motors one by one. The calibration method for the lens testing station 100 calculates a final error value by adding the errors of both the lens actuator assembly 20 and the target actuator assembly 50, and then modify data of the original center coordinate 72a through a software correction way directly. Therefore, the calibration method for the lens testing station 100 is much faster.

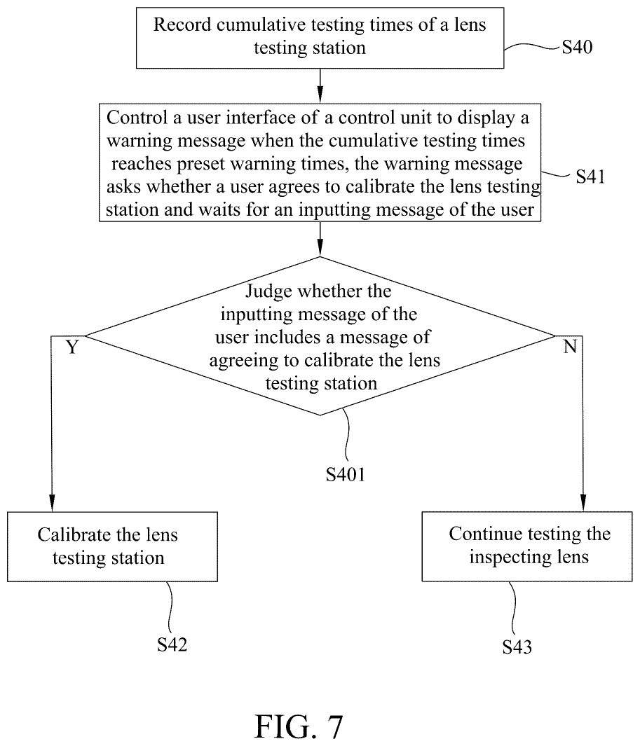

Referring to FIG. 1 to FIG. 7, the calibration method for the lens testing station 100 further includes a periodic calibration process of the lens testing station 100 to maintain a correct setting of the lens testing station 100. The periodic calibration process of the lens testing station 100 includes following steps.

Step S40: record cumulative testing times of the lens testing station 100 by the control unit 80. An initial value of the cumulative testing times of the lens testing station 100 is zero. When the control unit 80 completes testing the inspecting lens at the lens testing station 100, the cumulative testing times of the lens testing station 100 adds one. In the practice, when the lens testing station 100 completes the test for one time, the cumulative testing times of the lens testing station 100 adds one. That is to say, when the lens testing station 100 completes a circulation which is from the step S10 to the step S14 in sequence, the cumulative testing times of the lens testing station 100 adds one.

Step S41: control a user interface of the control unit 80 to display a warning message when the cumulative testing times reaches preset warning times storing in the storage medium of the control unit 80, the warning message asks whether the user agrees to calibrate the lens testing station 100 and waits for an inputting message of the user. In the practice, a value of the preset warning times is set to 500 according to an actual factory operation condition.

Step S401: judge whether the inputting message of the user includes a message of agreeing to calibrate the lens testing station 100. When the inputting message of the user received by the control unit 80 includes the message of agreeing to calibrate the lens testing station 100, execute the next step S42. When the inputting message of the user received by the control unit 80 includes a message of disagreeing to calibrate the lens testing station 100, execute a step S43 of continuing testing the inspecting lens by the lens testing station 100.

Step S42: calibrate the lens testing station 100, and reset the cumulative testing times of the lens testing station 100 to zero. In the practice, the user judges that the test of the inspecting lens at the lens testing station 100 is temporarily stopped and selects an agreement selection to calibrate the lens testing station 100, then start calibrating the lens testing station 100.

Step S43: continue testing the inspecting lens by the lens testing station 100. In the practice, the user may be unable to interrupt or finish the test of the inspecting lens on account of the lens testing station 100 still testing, so the user selects a disagreement selection, and the lens testing station 100 continues testing the inspecting lens.

The control unit 80 is a desktop computer which includes a screen and a keyboard, a laptop, or any component or device which is suitable for a displaying interface and is capable of receiving the inputting message of the user. The component or the device has functions of a data access, a data calculation, a data storage, or similar functions. The component or the device is unlimited to have the functions of the data access, the data calculation, the data storage, or the similar functions.

As described above, the calibration method for the lens testing station 100 uses the corrected original center coordinate as the criterion to determine whether the inspecting lens passes the test, and the calibration method for the lens testing station 100 is capable of correcting an own setup variation of the lens testing station 100 quickly and automatically, so proceeding time of calibration operations is reduced, an accuracy and a reliability of the calibrated lens testing station 100 are simultaneously improved, and an efficiency of a factory operation process is improved.

What is claimed is:

1. A calibration method for a lens testing station, the lens testing station including a base, a lens actuator assembly fixed on the base, a lens holder mounted on the lens actuator assembly, an image capture unit mounted on the lens holder, a target actuator assembly disposed to one side of the base, a testing pattern arranged at the target actuator assembly, and a control unit electrically connected to the lens actuator assembly, the image capture unit and the target actuator assembly, the image capture unit being positioned at an optical axis of a calibrating lens, the calibration method for the lens testing station comprising steps of:
installing the calibrating lens on the lens holder;
controlling the lens actuator assembly and the target actuator assembly by the control unit, and the lens actuator assembly and the target actuator assembly being controlled according to preset data, the calibrating lens being aligned with the testing pattern, shot times of a calibration image being returned to zero;
capturing the testing pattern by the calibrating lens and the image capture unit, the image capture unit capturing the calibration image and transmitting the calibration image to the control unit;
calculating a central coordinate of the calibration image by the control unit, and calculating an offset of the central coordinate relative to an original center coordinate storing in a storage medium of the control unit, the control unit storing the offset in the storage medium of the control unit to make the offset accessible by the control unit, the control unit adding one to the shot times of the calibration image;
checking whether the shot times of the calibration image are less than preset capturing times storing in the storage medium by the control unit, repeating the steps of capturing the testing pattern and calculating the central coordinate of the calibration image when the shot times of the calibration image are less than the preset capturing times, executing the next step when the shot times of the calibration image are equal to the preset capturing times; and
calculating an average offset of all stored offsets by the control unit, adding the average offset to the original center coordinate to obtain a corrected original center coordinate, and storing the corrected original center coordinate in the storage medium of the control unit, then, when the lens testing station tests an inspecting lens, the control unit using the corrected original center coordinate to replace the original center coordinate to proceed with a test of the lens testing station.

2. The calibration method for the lens testing station as claimed in claim 1, wherein the image capture unit captures a standard image through the calibrating lens, when the lens testing station is initially established, the control unit calculates a center point of the standard image which is generated from the calibrating lens fixed on the lens holder to obtain the original center coordinate.

3. The calibration method for the lens testing station as claimed in claim 1, wherein the calibrating lens is inspected and is correctly assembled, the calibrating lens is nearly error-free.

4. The calibration method for the lens testing station as claimed in claim 1, further comprising a periodic calibration process of the lens testing station to maintain a correct setting of the lens testing station, the periodic calibration process of the lens testing station comprising steps of:
recording cumulative testing times of the lens testing station by the control unit;
controlling a user interface of the control unit to display a warning message when the cumulative testing times reaches preset warning times, the warning message asking whether a user agrees to calibrate the lens testing station and waiting for an inputting message of the user;
judging whether the inputting message of the user includes a message of agreeing to calibrate the lens testing station, when the inputting message of the user received by the control unit includes the message of agreeing to calibrate the lens testing station, execute the next step, when the inputting message of the user received by the control unit includes a message of disagreeing to calibrate the lens testing station, execute a step of continuing testing the inspecting lens by the lens testing station;
calibrating the lens testing station, and resetting the cumulative testing times of the lens testing station to zero; and
continuing testing the inspecting lens by the lens testing station.

5. The calibration method for the lens testing station as claimed in claim 4, wherein an initial value of the cumulative testing times of the lens testing station is zero, when the control unit completes testing the inspecting lens at the lens testing station, the cumulative testing times of the lens testing station adds one.

6. The calibration method for the lens testing station as claimed in claim 4, wherein the calibration method for the lens testing station calculates a final error value by adding errors of both the lens actuator assembly and the target actuator assembly, and then modify data of the original center coordinate through a software correction way directly.

7. The calibration method for the lens testing station as claimed in claim 1, wherein the lens actuator assembly includes a first linear sliding rail, a second linear sliding rail, a first rotating platform and a second rotating platform, a track of the first linear sliding rail is parallel to a top surface of the base, the second linear sliding rail is connected to a slider of the first linear sliding rail, the track of the first linear sliding rail is perpendicular to a track of the second linear sliding rail, the first rotating platform is connected to a slider of the second linear sliding rail, the second rotating platform is connected to a surface of the first rotating platform, a rotation axis of the first rotating platform is perpendicular to the top surface of the base, a rotation axis of the second rotating platform is perpendicular to the rotation axis of the first rotating platform, the rotation axis of the second rotating platform is parallel to the track of the first linear sliding rail, the first linear sliding rail, the second linear sliding rail, the first rotating platform and the second rotating platform are all driven by servo motors, so that the lens holder is in alignment with a specified direction according to an instruction.

8. The calibration method for the lens testing station as claimed in claim 7, wherein the target actuator assembly includes a third linear sliding rail, and a third rotating platform disposed to a slider of the third linear sliding rail, a track of the third linear sliding rail, a rotation axis of the third rotating platform and the track of the first linear sliding rail are parallel, the third linear sliding rail and the third rotating platform are driven by the servo motors, a movement of the slider of the third linear sliding rail drives the testing pattern to move away from or move close to the lens holder, a rotation of a surface of the third rotating platform drives the testing pattern to slightly move away from or move close to the lens holder, so a relative distance between the testing pattern and the lens holder is adjusted, and a relative angle between the testing pattern and the lens holder is adjusted.

9. A calibration method for a lens testing station, the lens testing station including a base, a lens actuator assembly fixed on the base, a lens holder mounted on the lens actuator assembly, an image capture unit mounted on the lens holder, a target actuator assembly disposed to one side of the base, a testing pattern arranged at the target actuator assembly, and a control unit electrically connected to the lens actuator assembly, the image capture unit and the target actuator assembly, the image capture unit being positioned at an optical axis of a calibrating lens, the image capture unit capturing a standard image through the calibrating lens, when the lens testing station is initially established, the control unit calculating a center point of the standard image to obtain an original center coordinate, the calibration method for the lens testing station comprising steps of:
installing the calibrating lens on the lens holder;
controlling the lens actuator assembly and the target actuator assembly by the control unit, the calibrating lens being aligned with the testing pattern, shot times of a calibration image being returned to zero;
capturing the testing pattern by the calibrating lens and the image capture unit, the image capture unit capturing the calibration image and transmitting the calibration image to the control unit;
calculating a central coordinate of the calibration image by the control unit, and calculating an offset of the central coordinate relative to the original center coordinate storing in the control unit, the control unit storing the offset in the control unit to make the offset accessible by the control unit, the control unit adding one to the shot times of the calibration image;
checking whether the shot times of the calibration image are less than preset capturing times storing in the control unit by the control unit, repeating the steps of capturing the testing pattern and calculating the central coordinate of the calibration image when the shot times of the calibration image are less than the preset capturing times, executing the next step when the shot times of the calibration image are equal to the preset capturing times; and
calculating an average offset of all stored offsets by the control unit, adding the average offset to the original center coordinate to obtain a corrected original center coordinate, and storing the corrected original center coordinate in the control unit, then, when the lens testing station tests an inspecting lens, the control unit using the corrected original center coordinate to replace the original center coordinate to proceed with a test of the lens testing station.

10. A calibration method for a lens testing station, comprising:
capturing a standard image through a calibrating lens when the lens testing station is initially established, the standard image being arranged at a target actuator assembly, the calibrating lens being mounted to an image capture unit of a lens holder of a lens actuator assembly;
calculating a center point of the standard image by a control unit to obtain an original center coordinate;
installing a calibrating lens on the lens holder;
moving the lens actuator assembly and the target actuator assembly according to an instruction of the control unit, the calibrating lens being aligned with a testing pattern arranged at the target actuator assembly, shot times of a calibration image being returned to zero;
capturing the testing pattern by the calibrating lens and the image capture unit, the image capture unit capturing the calibration image and transmitting the calibration image to the control unit;
calculating a central coordinate of the calibration image by the control unit, and calculating an offset of the central coordinate relative to the original center coordinate, the control unit storing the offset in the control unit to make the offset accessible by the control unit, the control unit adding one to the shot times of the calibration image;
checking whether the shot times of the calibration image are less than preset capturing times storing in the control unit by the control unit,
repeating the steps of capturing the testing pattern and calculating the central coordinate of the calibration image when the shot times of the calibration image are less than the preset capturing times; and
calculating an average offset of all stored offsets by the control unit when the shot times of the calibration image are equal to the preset capturing times, adding the average offset to the original center coordinate to obtain a corrected original center coordinate, and storing the corrected original center coordinate in the control unit, then, when the lens testing station tests an inspecting lens, the control unit using the corrected original center coordinate as a criterion to determine whether the inspecting lens passes the test.
